(19) United States
(12) Patent Application Publication
(10) Pub. No.: US 2014/0177101 A1
(43) Pub. Date: Jun. 26, 2014

(54) MAGNETIC HEAD AND MAGNETIC RECORDING/REPRODUCTION APPARATUS

(71) Applicant: Kabushiki Kaisha Toshiba, Minato-ku (JP)

(72) Inventors: Katsuhiko KOUI, Yokohama-shi (JP); Shuichi Murakami, Tokyo (JP); Mariko Shimizu, Kawasaki-shi (JP); Kenichiro Yamada, Tokyo (JP)

(73) Assignee: Kabushiki Kaisha Toshiba, Minato-ku (JP)

(21) Appl. No.: 13/903,219

(22) Filed: May 28, 2013

(30) Foreign Application Priority Data
Dec. 21, 2012 (JP) 2012-279302

(51) Int. Cl. G11B 5/147

(52) U.S. Cl. CPC G11B 5/147
USPC 360/125.06

(57) ABSTRACT

According to one embodiment, an oscillation layer of a spin torque oscillator for use in a magnetic head includes a stack of first and second metal films. The first metal film is formed by repetitively stacking a combination of first and second magnetic layers twice or more. The thickness of the first metal film is 0.4 to 5.0 nm. The first magnetic layer has a bcc structure and contains Fe. The second magnetic layer contains Co. The second metal film is made of Cu.

### CROSS-REFERENCE TO RELATED APPLICATIONS

This application is based upon and claims the benefit of priority from Japanese Patent Application No. 2012-279302, filed Dec. 21, 2012, the entire contents of which are incorporated herein by reference.

### FIELD

Embodiments described herein relate generally to a magnetic head and magnetic recording/reproduction apparatus.

### BACKGROUND

In the 1990s, a magnetoresistive effect (MR) head and giant magnetoresistive effect (GMR) head were put to practical use, and this dramatically increased the recording density and recording capacity of a hard disk drive (HDD). In the 2000s, however, the problem of thermal fluctuation of a magnetic recording medium became conspicuous, and the increasing speed of the recording density temporarily decreased. Still, the recording density of the HDD is recently increasing by about 40% per year because perpendicular magnetic recording more advantageous for high-density recording in principle than in-plane magnetic recording was put to practical use in 2005.

Even when using this perpendicular magnetic recording method, however, it is probably not easy to increase the recording density because the problem of thermal fluctuation becomes conspicuous again.

A microwave-assisted magnetic recording method has been proposed as a recording method capable of solving this problem. In this microwave assisted magnetic recording method, a microwave magnetic field near the resonance frequency of a magnetic recording medium, which is much higher than a recording signal frequency, is locally applied to the medium. Consequently, the magnetic recording medium resonates, and the coercive force (Hc) of the magnetic recording medium to which the microwave magnetic field is applied becomes half or less the original coercive force. By superposing a microwave magnetic field on a recording magnetic field, therefore, magnetic recording can be performed on a magnetic recording medium having a higher coercive force (Hc) and higher magnetic anisotropic energy (Ku).

Unfortunately, it is difficult to stably apply a desired microwave magnetic field during high-density recording.

### BRIEF DESCRIPTION OF THE DRAWINGS

FIG. 1 is a schematic view showing an example of the arrangement of a spin torque oscillator for use in an embodiment;

FIG. 2 is a schematic view showing another example of the arrangement of the spin torque oscillator for use in the embodiment;

FIG. 3 is a schematic view showing an example of the arrangement of a magnetic head according to the embodiment;

FIG. 4 is a perspective view showing an outline of the arrangement of the main part of a magnetic recording/reproduction apparatus capable of incorporating the magnetic head according to the embodiment; and

FIG. 5 is a schematic view showing an example of a magnetic head assembly according to the embodiment.

### DETAILED DESCRIPTION

In general, according to one embodiment, a magnetic head includes

a main magnetic pole for applying a recording magnetic field to a magnetic recording medium,

an auxiliary magnetic pole for forming a magnetic circuit together with the main magnetic pole, and

a spin torque oscillator formed between the main magnetic pole and auxiliary magnetic pole.

The spin torque oscillator includes an oscillation layer formed on one of the main magnetic pole and auxiliary magnetic pole, an interlayer formed on the oscillation layer, and a spin injection layer formed on the interlayer.

The oscillation layer includes a stack of first and second metal films.

The first metal film is formed by repetitively stacking a combination of first and second magnetic layers twice or more. The thickness of the first metal film is 0.4 to 5.0 nm.

The first magnetic layer has a bcc structure and contains iron (Fe).

The second magnetic layer contains cobalt (Co).

The second metal film is made of copper (Cu).

Also, a magnetic recording/reproduction apparatus according to the embodiment includes the above-mentioned magnetic head.

The embodiment will be explained below with reference to the accompanying drawings.

Since the embodiment includes the oscillation layer having the above-mentioned arrangement, it is possible to obtain a magnetic head capable of stably applying a desired microwave magnetic field during high-density recording.

According to the embodiment, in a spin torque oscillator (STO) including an oscillation layer (FGL), nonmagnetic interlayer, and spin injection layer (SIL), perpendicular magnetic anisotropy capable of reducing an effective demagnetizing field can be given to the FGL. More specifically, it is possible to effectively reduce the crystal symmetry and achieve perpendicular magnetic anisotropy by giving the FGL an artificial lattice structure obtained by stacking a bcc alloy, Co alloy, and Cu, and incorporating Fe, which is advantageous in increasing saturation magnetic flux density (Bs). More specifically, it is possible to use a structure in which a Cu layer is inserted into an Fe/Co artificial lattice structure, e.g., a structure represented by ((Fe/Co)n/Cu)m (n and m are integers). This can achieve both a high Bs and perpendicular magnetic anisotropy resulting from strain caused by the Cu layer.

If the film thickness of (Fe/Co)n becomes very large and the frequency of Cu relatively decreases, the effect of strain on the whole film decreases, so no sufficient perpendicular magnetic anisotropy can be obtained. More specifically, if the film thickness of (Fe/Co)n exceeds 5 nm, lattice relaxation occurs before the effect of strain from Cu reaches the whole film, so it is impossible to sufficiently decrease the crystallinity.

Also, if the number n of times of stacking of (Fe/Co)n is too small, the decrease in crystal symmetry caused by the periodic structure of the artificial lattice cannot be achieved. More specifically, n must be 2 or more. In addition, if the film thickness of Fe and Co is too large, the characteristics of each element appear, and the effect unique to the artificial lattice disappears. Therefore, the thickness of each layer can be 3 nm or less.

Furthermore, each of the Fe layer and Co layer forming (Fe/Co)n must have a film thickness of at least 0.1 nm. If the film thickness is less than 0.1 nm, the crystallinity of an Fe—Co-based alloy appears, and a highly symmetrical cubic system forms. This makes the anisotropy unique to the artificial lattice disappear.

Since n must be 2 or more, the thickness of (Fe/Co)n is at least 0.4 nm.

On the other hand, if the film thickness of Cu is too small, it often becomes difficult to apply strain to the periphery. Accordingly, Cu can have a film thickness of 0.1 nm. If the film thickness is larger than 2 nm, magnetic coupling obtained via Cu is lost, and the oscillation layer is given a domain structure. This tends to weaken a microwave magnetic field. Therefore, the Cu film thickness can be decreased as much as possible within a range over which perpendicular magnetic anisotropy can be obtained.

Although the structure combining the Fe, Co, and Cu layers has been explained so far, perpendicular magnetic anisotropy can be obtained even when the Fe layer is an Fe—Co alloy as long as the alloy has a bcc phase. More specifically, the bcc phase can be obtained by an Fe—Co alloy such as Fe₅₀Co₅₀, Fe₈₀Co₂₀, or Fe₃₀Co₇₀ containing Fe at a composition ratio higher than 25 at %. To more stably obtain bcc, Fe can be incorporated at 30 at % or more. If the content of Fe is 25 at % or less, an fcc phase appears, so no desired effect can be obtained. These bcc Fe—Co alloys can also contain other metal elements. More specifically, it is possible to hold the bcc phase and obtain a desired effect even when an element selected from aluminum (Al), silicon (Si), copper (Cu), germanium (Ge), gallium (Ga), and manganese (Mn) is added at a composition ratio of 30 at % or less. The Co layer need only be a Co-containing magnetic layer, and can also be a Co—Fe alloy such as Co₉₀Fe₁₀ or Co₈₀Fe₂₀ containing Co at a composition ratio of 75 at % or more. These fcc Co—Fe alloys can also contain other metal elements. More specifically, it is possible to hold the fcc phase and obtain a desired effect even when an element selected from Al, Si, Cu, Ge, Ga, and Mn is added at a composition ratio of 30 at % or less.

FIG. 1 is a schematic view showing an example of the arrangement of the spin torque oscillator for use in the embodiment.

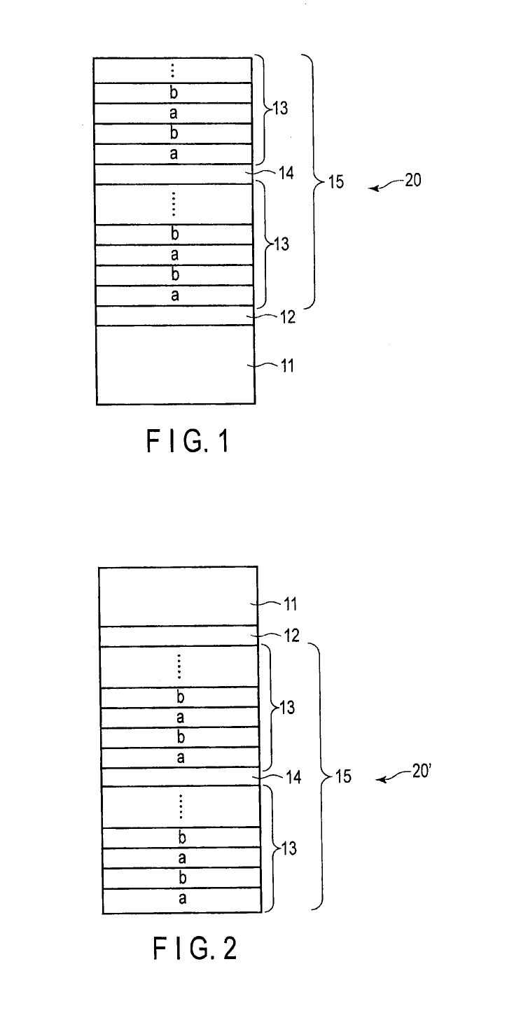

FIG. 2 is a schematic view showing another example of the arrangement of the spin torque oscillator for use in the embodiment.

As shown in FIG. 1, a spin torque oscillator 20 includes a spin injection layer 11 formed on one of a main magnetic pole and auxiliary magnetic pole, a nonmagnetic interlayer 12 formed on the spin injection layer 11, and an oscillation layer 15 formed on the nonmagnetic interlayer 12.

The oscillation layer 15 includes a stack of first and second metal films 13 and 14.

Referring to FIG. 1, a and b respectively indicate a bcc layer and Co alloy layer.

The first metal film 13 has a structure in which a combination (a/b) of the bcc layer and Co-containing layer is stacked n times.

The oscillation layer 15 is obtained by further stacking a combination ((a/b)n/Cu) of the first and second metal films 13 and 14 m times.

The oscillation layer 15 has a structure represented by ((a/b)n/Cu)m (n and m are integers).

In FIG. 1, the layers forming the first metal film 13 are stacked in the order of a and b when viewed from the spin injection layer 11. In a spin torque oscillator 20′ as shown in FIG. 2, however, these layers are stacked in the order of b and a.

As the nonmagnetic interlayer, it is possible to use a nonmagnetic alloy layer or multilayered film made of at least one metal or a plurality of metals selected from the group consisting of Cu, gold (Au), silver (Ag), platinum (Pt), Al, palladium (Pd), osmium (Os), and iridium (Ir). The thickness of the nonmagnetic interlayer must be smaller than the spin diffusion length, because spin torque is transferred from the SIL to the FGL. Although the spin diffusion length changes from one material to another, it is generally 10 nm or more. Accordingly, the thickness of the nonmagnetic interlayer can be 10 nm or less. On the other hand, if the thickness is smaller than 0.5 nm, the FGL and SIL strongly magnetically couple with each other, and this hinders oscillation. Therefore, the thickness can be 0.5 nm or more.

The SIL has perpendicular magnetic anisotropy, and, in the presence of a gap magnetic field, can stably point in the direction of the gap magnetic field. On the other hand, when polarization reversal occurs in the gap magnetic field, the SIL can reverse and point in the same direction as that of the gap magnetic field. More specifically, it is possible to use a Co—Pt alloy, Fe—Pt alloy, Co/Pt artificial lattice, Co/Pd artificial lattice, Co/Ni artificial lattice, or FeCo/Ni artificial lattice. As the film thickness of the SIL increases, the magnetization direction stabilizes during spin torque oscillation. However, the SIL can be formed as thin as possible because the STO can be formed thin as a whole in order to downsize a magnetic head. More specifically, stable oscillation can be achieved when the film thickness is 5 nm or more.

A soft magnetic layer can also be formed between the SIL and nonmagnetic interlayer. When an FeCo alloy or half-metal alloy is formed, it is possible to increase the spin torque efficiency and decrease the driving voltage, thereby improving the reliability. On the other hand, when the soft magnetic layer is formed by stacking layers, the perpendicular magnetic anisotropy decreases as a whole, so the film thickness must be set so as not to significantly decrease the perpendicular magnetic anisotropy. The film thickness depends on the intensity of the perpendicular magnetic anisotropy of the SIL and its film thickness. When the film thickness does not exceed the film thickness of the SIL, however, perpendicular magnetic anisotropy can be obtained to a certain degree.

Also, the SIL and FGL are electrically connected to the main magnetic pole and auxiliary magnetic pole as magnetic poles also serving as electrodes. However, if the FGL is directly connected to the magnetic pole, the driving voltage necessary for magnetic coupling and oscillation rises. Therefore, a nonmagnetic metal layer can be formed between the FGL and magnetic pole. More specifically, it is possible to use a nonmagnetic alloy layer or multilayered film made of at least one metal or a plurality of metals selected from Cu, Au, Ag, Pt, Al, Pd, Os, and Ir. Furthermore, the FGL and SIL are each electrically connected to one of the main magnetic pole and auxiliary magnetic pole, and the FGL can be connected to either the main magnetic pole or auxiliary magnetic pole. This similarly applies to the SIL.

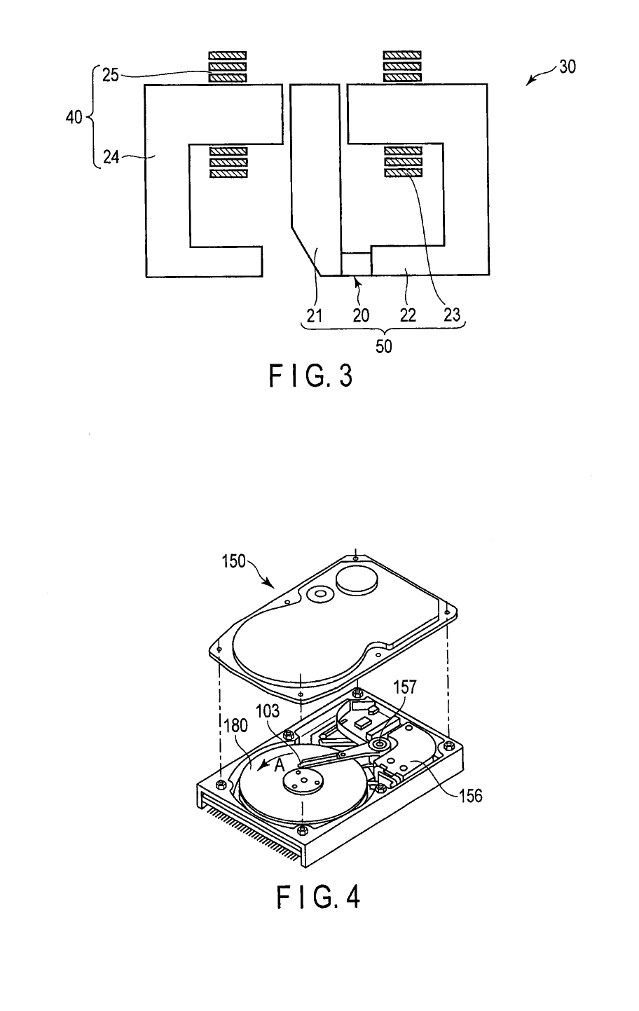

FIG. 3 is a schematic view showing an example of the magnetic head according to the embodiment.

A magnetic head 30 according to the embodiment includes a read head unit 40 and write head unit 50. The read head unit 40 includes a magnetic read element (not shown), excitation coil 25, and leading shield 24. The write head unit 50 includes a main magnetic pole 21 as a recording magnetic pole, a trailing shield (auxiliary magnetic pole) 22 for returning a magnetic field from the main magnetic pole 21, a spin torque oscillator 20 formed between the main magnetic pole 21 and trailing shield (auxiliary magnetic pole) 22, and an excitation coil 23. In the write head unit 50 of the microwave magnetic field assisted recording head 30, a gap magnetic field between the main magnetic pole 21 and trailing shield 22 applies an external magnetic field perpendicular to the film surfaces. Consequently, the oscillation layer performs precession around an axis almost perpendicular to the film surfaces as a rotational axis, thereby generating a microwave magnetic field outside. By superposing this microwave magnetic field generated from the spin torque oscillator on a magnetic field applied from the main magnetic pole, data can be written on a magnetic recording medium more suited to a high recording density.

In the embodiment, the spin torque oscillator having a low critical current density can be used as a microwave magnetic field generating source. This makes it possible to reverse the magnetization of the magnetic recording medium with a large microwave magnetic field.

FIG. 4 is a perspective view showing an outline of the arrangement of the main part of a magnetic recording/reproduction apparatus capable of incorporating the magnetic head according to the embodiment.

That is, a magnetic recording/reproduction apparatus 150 is an apparatus using a rotary actuator. Referring to FIG. 4, a recording medium disk 180 is fitted on a spindle 152, and rotated in the direction of an arrow A by a motor (not shown) that responds to a control signal from a driver controller (not shown). The magnetic recording/reproduction apparatus 150 may also include a plurality of medium disks 180.

A head slider 103 for performing recording and reproduction of information to be stored in the medium disk 180 has the arrangement as described above with reference to FIG. 3, and is attached to the distal end of a thin-film suspension 154. The magnetic head according to the embodiment, for example, is mounted near the distal end of the head slider 103.

When the medium disk 180 rotates, the air bearing surface (ABS) of the head slider 103 is held with a predetermined floating amount from the surface of the medium disk 180. The head slider 103 may also be a so-called “contact running slider” that comes into contact with the medium disk 180.

The suspension 154 is connected to one end of an actuator arm 155 including a bobbin for holding a driving coil (not shown). A voice coil motor 156 as a kind of a linear motor is formed at the other end of the actuator arm 155. The voice coil motor 156 includes the driving coil (not shown) wound around the bobbin of the actuator arm 155, and a magnetic circuit including a permanent magnet and counter-yoke facing each other so as to sandwich the coil between them.

The actuator arm 155 is held by ball bearings (not shown) formed in upper and lower portions of a spindle 157 and freely slid by the voice coil motor 156.

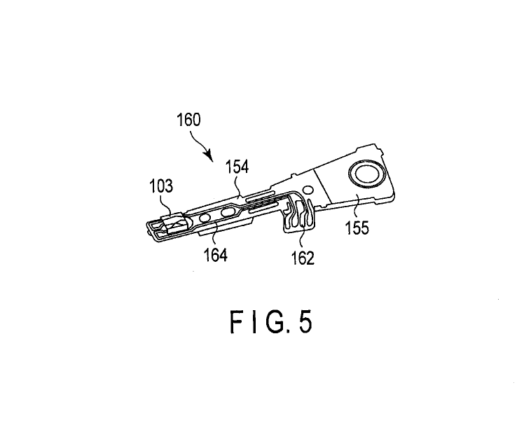

FIG. 5 is a schematic view showing an example of a magnetic head assembly according to the embodiment.

FIG. 5 is an enlarged perspective view showing, from the disk side, a magnetic head assembly formed ahead of an actuator arm 155. That is, a magnetic head assembly 160 includes the actuator arm 155 including a bobbin for holding a driving coil, and a suspension 154 is connected to one end of the actuator arm 155.

A head slider 103 including the magnetic head 30 shown in FIG. 3 is attached to the distal end of the suspension 154. The suspension 154 has lead wires 164 for signal write and read, and the lead wires 164 are electrically connected to the electrodes of the magnetic head incorporated into the head slider 103. Reference number 162 shown in FIG. 5 denotes electrode pads of the magnetic head assembly 160.

### EXAMPLES

The embodiment will be explained in detail below by way of its examples.

### Example 1

A spin torque oscillator having structure 1 below was manufactured.

First, layers from an underlayer to a cap layer were formed on a 200-nm-thick Fe—Co alloy layer as an electrode in the following order by using the following materials. The deposition method was DC magnetron sputtering, and the deposition conditions were that the back pressure was 2×10⁻⁶ Pa and the argon partial pressure was 2×10⁻¹ Pa. Then, the obtained stack from the underlayer to the cap layer was downsized into a square of 40 nm side, and this square stack was buried by a silicon oxide. After that, a 200-nm-thick Fe—Co—Ni alloy layer was formed as another electrode on top of the stack, and interconnections were formed so as to supply an electric current perpendicularly to the film surfaces of the stack.

### Structure 1:

Underlayer Ta 3 nm/Pt 2 nm
Spin injection layer (Co 0.5 nm/Pt 0.5 nm)×stacked 5 times
Soft magnetic layer FeCo 1 nm
Nonmagnetic interlayer Cu 2 nm
First magnetic layer (Fe 0.1 nm/Co 0.1 nm)×stacked 10 times
Second metal layer Cu 0.5 nm
Nonmagnetic layer Cu 1 nm
Cap layer Ru 10 nm

An anisotropic magnetic field Hk of the obtained spin torque oscillator was measured by performing magnetization measurement on a square sample of 1 cm side deposited on a silicon oxide substrate by using exactly the same structure as above. Consequently, the anisotropic magnetic field Hk was 5,000 Oe.

In addition, the crystal structure of the FGL was analyzed by electron beam diffraction and found to be a bcc structure. Furthermore, the multilayered lattice spacing was measured and found to be 2.015 Å.

While a driving current was applied to the STO, an Hgap to be applied to the spin torque oscillator in the head structure shown in FIG. 3 was applied perpendicularly to the film surfaces, and the oscillation frequency was measured. Consequently, the oscillation frequency was 25 GHz in Example 1 in which the Hk was applied.

The thickness of the first magnetic layer was 10 nm (0.2 nm×10 times×5 times).

Table 1 below shows the multilayered structure of the spin torque oscillator and the obtained measurement results.

### Example 2

A spin torque oscillator was manufactured following the same procedures as in Example 1 except that the thickness of the second metal layer Cu was changed to 0.2 nm.

Measurements were performed on the obtained spin torque oscillator in the same manner as in Example 1. Table 1 below shows the results and the thickness of the first magnetic layer.

### Comparative Example 1

A spin torque oscillator was manufactured following the same procedures as in Example 1 except that the first magnetic layer (Fe 0.1 nm/Co 0.1 nm) was stacked 50 times and no second magnetic layer Cu was formed.

Measurements were performed on the obtained spin torque oscillator in the same manner as in Example 1. Table 1 below shows the results and the thickness of the first magnetic layer.

### Comparative Example 2

A spin torque oscillator was manufactured following the same procedures as in Example 1 except that a combination of 0.1-nm-thick Co₉₀Fe₁₀ having the fcc structure and 0.1-nm-thick Cu was stacked 10 times instead of the first magnetic layer.

Measurements were performed on the obtained spin torque oscillator in the same manner as in Example 1. Table 1 below shows the results and the thickness of the first magnetic layer.

### Comparative Example 3

A spin torque oscillator was manufactured following the same procedures as in Example 1 except that 10-nm-thick FeCo was formed as a single bcc-FeCo layer instead of the first and second magnetic layers.

Measurements were performed on the obtained spin torque oscillator in the same manner as in Example 1. Table 1 below shows the results and the thickness of the first magnetic layer.

Table 1 below shows the examples and comparative examples.

TABLE 1

| | | | | | Oscillation | |
|---|---|---|---|---|---|---|
| | | | Hk | bcc(110)-lattice | frequency | Thickness |
| Sample | | Spin torque oscillator arrangement | (Oe) | spacing (nm) | (GHz) | (nm) |
| Example | 1 | Ta 3 nm/Pt 2 nm/(Co 0.5 nm/Pt 0.5 nm) × | 5000 | 2.015 | 25 | 10 |
| | | 5 times/FeCo 1 nm/Cu 2 nm/[(Fe 0.1 nm/Co 0.1 nm) × | | | | |
| | | 10 times/Cu 0.5 nm] × 5 times/Cu 1 nm/Ru 10 nm | | | | |
| | 2 | Ta 3 nm/Pt 2 nm/(Co 0.5 nm/Pt 0.5 nm) × | 3000 | 2.023 | 23 | 10 |
| | | 5 times/FeCo 1 nm/Cu 2 nm/[(Fe 0.1 nm/Co 0.1 nm) × | | | | |
| | | 10 times/Cu 0.2 nm] × 5 times/Cu 1 nm/Ru 10 nm | | | | |
| Comparative | 1 | Ta 3 nm/Pt 2 nm/(Co 0.5 nm/Pt 0.5 nm) × | 0 | 2.032 | 15 | 10 |
| Example | | 5 times/FeCo1 nm/Cu 2 nm/(Fe 0.1 nm/Co 0.1 nm) × | | | | |
| | | 50 times/Cu 1 nm/Ru 10 nm | | | | |
| | 2 | Ta 3 nm/Pt 2 nm/(Co 0.5 nm/Pt 0.5 nm) × | 0 | No bcc phase | 16 | 10 |
| | | 5 times/FeCo 1 nm/Cu 2 nm/[(Co₉₀Fe₁₀ 0.1 nm/Co 0.1 nm) × | | (fcc) | | |
| | | 10 times/Cu 0.2 nm] × 5 times/Cu 1 nm/Ru 10 nm | | | | |
| | 3 | Ta 3 nm/Pt 2 nm/(Co 0.5 nm/Pt 0.5 nm) × | 0 | 2.011 | 12 | 10 |
| | | 5 times/FeCo 1 nm/Cu 2 nm/FeCo 10 nm/Cu 1 nm/Ru 10 nm | | | | |

Note that in Table 1, (Co 0.5 nm/Pt 0.5 nm)×times, for example, indicates that a combination of 0.5-nm-thick Co and 0.5-nm-thick Pt was repetitively stacked 5 times.

In Comparative Example 3, a single bcc-FeCo layer was used as the FGL. Since the magnetization of bcc-FeCo reaches 2.4 teslas, a demagnetizing field is very large. In addition, bcc-FeCo has no perpendicular magnetic anisotropy, the demagnetizing field of the FGL is much larger than the Hgap, and this decreases the magnetic field to be effectively applied to the FGL. Consequently, the oscillation frequency hardly rises.

Each of Examples 1 and 2 was the STO using the structure in which Cu was inserted into the Fe/Co artificial lattice. Perpendicular magnetic anisotropy was given to the spin injection layer (SIL) by using the Co/Pt artificial lattice.

In the STO of Comparative Example 1, a similar SIL was used, and the Fe/Co artificial lattice in which no Cu was inserted was used as the FGL. In Comparative Example 2, Co₉₀Fe₁₀ was used instead of Fe. These films were stacked on the main magnetic pole of a perpendicular magnetic recording head, and the stack was patterned into a square of 40 nm side, thereby forming an STO. In addition, an auxiliary magnetic pole was stacked, and processing was performed so that the gap magnetic field (Hgap) perpendicular to the STO film surfaces was applied between the main magnetic pole and auxiliary magnetic pole at the same time a recording magnetic field was generated. Magnetization measurement was performed on these film configurations before the processing, thereby estimating the Hk. Also, the crystal structure of the Fe layer was analyzed by electron beam diffraction.

Consequently, the Hk appeared in Examples 1 and 2. The values of the Hk increased as the film thickness of Cu increased. When the crystal structure of the FGL of each film was analyzed, the crystal structure was found to be a bcc structure. Since the Fe layer was very thin, the Co layer was also irradiated with an electron beam, but all layers had the bcc structure. In addition, the multilayered lattice spacing was measured. Consequently, the symmetry was decreased in the stacking direction by inserting Cu as the second metal layer between the first metal layers, and perpendicular magnetic anisotropy was obtained by this effect.

In Comparative Example 2, the Hk was lost because Fe was replaced with Co₉₀Fe₁₀. The crystal structure of this film was fcc. In each of Examples 1 and 2 and Comparative Examples 1 and 2, the oscillation frequency was measured by generating an Hgap while applying a driving current to the STO. Consequently, a frequency exceeding 20 GHz was obtained in each of Examples 1 and 2 in which the Hk was applied. On the other hand, the oscillation frequency was 20 GHz or less in each of Comparative Examples 1 and 2 in which no Hk was applied.

### Examples 3, 4, and 5 and Comparative Example 4

To examine an FGL film configuration capable of effectively obtaining an Hk, only the first metal film was deposited and its Hk was checked.

First, layers from an underlayer to a cap layer were formed on a thermally oxidized silicon substrate in the following order by using the materials of structure 2 below. The deposition method was DC magnetron sputtering, and the deposition conditions were that the back pressure was 2×10⁻⁶ Pa and the argon partial pressure was 2×10⁻¹ Pa.

### Structure 2:

### Underlayer Ta 3 nm

Second metal layer Cu 2 nm
First magnetic layer The number of times of stacking of (Fe 0.1 nm/Co 0.1 nm) was changed to 5, 10, 20, and 30.
Second metal layer Cu 2 nm
Cap layer Ta 2 nm

The Hk of the obtained stack was measured in the same manner as in Example 1.

Table 2 below shows the results and the thickness of the first magnetic layer.

TABLE 2

| | | Thickness | Hk |
|---|---|---|---|
| Sample | Layer arrangement | (nm) | (Oe) |
| Example 3 | Ta 3 nm/Cu 2 nm/(Fe 0.1 nm/ | 1 | 15000 |
| | Co 0.1 nm) × 5/Cu 2 nm/Ta 3 nm | | |
| Example 4 | Ta 3 nm/Cu 2 nm/(Fe 0.1 nm/ | 2 | 8000 |
| | Co 0.1 nm) × 10/Cu 2 nm/Ta 3 nm | | |
| Example 5 | Ta 3 nm/Cu 2 nm/(Fe 0.1 nm/ | 4 | 2000 |
| | Co 0.1 nm) × 20/Cu 2 nm/Ta 3 nm | | |
| Comparative | Ta 3 nm/Cu 2 nm/(Fe 0.1 nm/ | 6 | 0 |
| Example 4 | Co 0.1 nm) × 30/Cu 2 nm/Ta 3 nm | | |

In each of Examples 3, 4, and 5, the Fe/Co artificial lattice was formed between the upper and lower Cu layers, and no Hk was obtained when the film thickness of the Fe/Co artificial lattice was 6 nm or more. This was so because strain from Cu relaxed. To superiorly obtain an Hk, the film thickness of the magnetic layer to be stacked on Cu can be 5 nm or less.

### Examples 6, 7, 8, and 9 and Comparative Examples 5 and 6

To examine an FGL film configuration capable of effectively obtaining an Hk, only the first metal film was deposited and its Hk was checked.

First, layers from an underlayer to a cap layer were formed on a thermally oxidized silicon substrate in the following order by using the materials of structure 3 below. The deposition method was DC magnetron sputtering, and the deposition conditions were that the back pressure was 2×10⁻⁶ Pa and the argon partial pressure was 2×10⁻¹ Pa.

### Structure 3:

### Underlayer Ta 3 nm

Second metal layer Cu 2 nm
First magnetic layer (Fe/Co)×5 times

In the first magnetic layer, the thicknesses of the Fe and Co layers were changed as shown in Table 3 below.

Second metal layer Cu 2 nm
Cap layer Ta 3 nm

The Hk of the obtained stack was measured in the same manner as in Example 1.

Table 3 below shows the results and the thickness of the first magnetic layer.

TABLE 3

| | | Thickness | Hk |
|---|---|---|---|
| Sample | Layer arrangement | (nm) | (Oe) |
| Example 6 | Ta 3 nm/Cu 2 nm/(Fe 1.5 nm/ | 5 | 1500 |
| | Co 1 nm) × 2/Cu 2 nm/Ta 3 nm | | |
| Example 7 | Ta 3 nm/Cu 2 nm/(Fe 2 nm/ | 5 | 1000 |
| | Co 0.5 nm) × 2/Cu 2 nm/Ta 3 nm | | |
| Comparative | Ta 3 nm/Cu 2 nm/(Fe 2.2 nm/ | 5 | 0 |
| Example 5 | Co 0.3 nm) × 2/Cu 2 nm/Ta 3 nm | | |
| Example 8 | Ta 3 nm/Cu 2 nm/(Fe 1 nm/ | 5 | 1500 |
| | Co 1.5 nm) × 2/Cu 2 nm/Ta 3 nm | | |
| Example 9 | Ta 3 nm/Cu 2 nm/(Fe 0.5 nm/ | 5 | 1000 |
| | Co 2 nm) × 2/Cu 2 nm/Ta 3 nm | | |
| Comparative | Ta 3 nm/Cu 2 nm/(Fe 0.3 nm/ | 5 | 0 |
| Example 6 | Co 2.2 nm) × 2/Cu 2 nm/Ta 3 nm | | |

In each example, the Fe/Co artificial lattice was formed between the upper and lower Cu layers. However, perpendicular magnetic anisotropy was lost in Comparative Example 8 in which the film thickness of Fe was 2.2 nm. This was so because the film thickness was too large, so the properties of the artificial lattice disappeared, and the properties of the material appeared. Likewise, perpendicular magnetic anisotropy was lost in Comparative Example 9 in which the film thickness of Co was 2.2 nm. To stably obtain perpendicular magnetic anisotropy, the film thickness of Fe and Co can be 2 nm or less.

### Examples 10 and 11 and Comparative Example 7

To examine an FGL film configuration capable of effectively obtaining an Hk, only the first metal film was deposited and its Hk was checked.

First, layers from an underlayer to a cap layer were formed on a thermally oxidized silicon substrate in the following order by using the materials of structure 4 below. The deposition method was DC magnetron sputtering, and the deposition conditions were that the back pressure was 2×10⁻⁶ Pa and the argon partial pressure was 2×10⁻¹ Pa.

### Structure 4:

### Underlayer Ta 3 nm

Second metal layer Cu 2 nm
First magnetic layer The number of times of stacking of (Fe 0.5 nm/Co 0.5 nm) was changed to 3, 2, and 1.
Second metal layer Cu 2 nm
Cap layer Ta 3 nm

The Hk of the obtained stack was measured in the same manner as in Example 1.

Table 4 below shows the results and the thickness of the first magnetic layer.

TABLE 4

| | | Thickness (nm) | |
|---|---|---|---|
| | | (number | |
| | | of times | Hk |
| Sample | Layer arrangement | of stacking) | (Oe) |
| Example 10 | Ta 3 nm/Cu 2 nm/(Fe 0.5 nm/ | 3 · (3 times) | 4000 |
| | Co 0.5 nm) × 3/Cu 2 nm/Ta 3 nm | | |
| Example 11 | Ta 3 nm/Cu 2 nm/(Fe 0.5 nm/ | 2 · (2 times) | 3000 |
| | Co 0.5 nm) × 2/Cu 2 nm/Ta 3 nm | | |
| Comparative | Ta 3 nm/Cu 2 nm/(Fe 0.5 nm/ | 1 · (1 time) | 0 |
| Example 7 | Co 0.5 nm) × 1/Cu 2 nm/Ta 3 nm | | |

Table 4 shows Examples 10 and 11 and Comparative Example 7. To examine an FGL film configuration capable of effectively obtaining an Hk, only the FGL structure was deposited and its Hk was checked. The Hk was obtained in Examples 10 and 11, but was lost in Comparative Example 7. This was so because the number of times of stacking was small, and this eliminated the bias of the structure symmetry in the direction perpendicular to the film surfaces, which was required to obtain perpendicular magnetic anisotropy. Accordingly, the number of times of repetition must be 2 or more.

Note that the STO is formed between the main magnetic pole and auxiliary magnetic pole as shown in FIG. 3.

On the air bearing surface, the main magnetic pole can be formed to have a length of about 20 to 200 nm in the direction of a recording track and a width of about 20 to 200 nm in the direction of an adjacent track. The STO can be formed to have the same size as the main magnetic pole width in the widthwise direction of the main magnetic pole, and can also be formed to be sandwiched between the main magnetic pole and auxiliary magnetic pole in the recording track direction. Furthermore, the STO can be processed to have a height of 20 to 200 nm from the air bearing surface.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic head comprising:
a main magnetic pole configured to apply a recording magnetic field to a magnetic recording medium;
an auxiliary magnetic pole configured to form a magnetic circuit together with the main magnetic pole; and
a spin torque oscillator formed between the main magnetic pole and the auxiliary magnetic pole,
wherein the spin torque oscillator includes an oscillation layer formed on one of the main magnetic pole and the auxiliary magnetic pole, an interlayer formed on the oscillation layer, and a spin injection layer formed on the interlayer,
the oscillation layer has a bcc structure, and includes a first metal film formed by repetitively stacking, not less than twice, a combination of a first magnetic layer containing iron and a second magnetic layer formed on the first magnetic layer and containing cobalt, and a second metal film formed on the first metal film and made of copper, and
a thickness of the first metal film is 0.4 to 5.0 nm.

2. The head according to claim 1, wherein the first magnetic layer and the second magnetic layer are made of different materials.

3. The head according to claim 1, wherein each of the first magnetic layer and the second magnetic layer has a thickness of 0.1 to 2 nm.

4. The head according to claim 1, wherein the first magnetic layer is made of iron, and the second magnetic layer is made of cobalt.

5. A magnetic recording/reproduction apparatus comprising a magnetic head comprising:
a main magnetic pole configured to apply a recording magnetic field to a magnetic recording medium;
an auxiliary magnetic pole configured to form a magnetic circuit together with the main magnetic pole; and
a spin torque oscillator formed between the main magnetic pole and the auxiliary magnetic pole,
wherein the spin torque oscillator includes an oscillation layer formed on one of the main magnetic pole and the auxiliary magnetic pole, an interlayer formed on the oscillation layer, and a spin injection layer formed on the interlayer,
the oscillation layer has a bcc structure, and includes a first metal film formed by repetitively stacking, not less than twice, a combination of a first magnetic layer containing iron and a second magnetic layer formed on the first magnetic layer and containing cobalt, and a second metal film formed on the first metal film and made of copper, and
a thickness of the first metal film is 0.4 to 5.0 nm.

6. The apparatus according to claim 5, wherein the first magnetic layer and the second magnetic layer are made of different materials.

7. The apparatus according to claim 5, wherein each of the first magnetic layer and the second magnetic layer has a thickness of 0.1 to 2 nm.

8. The apparatus according to claim 5, wherein the first magnetic layer is made of iron, and the second magnetic layer is made of cobalt.
